(19) United States
(12) Patent Application Publication
(10) Pub. No.: US 2026/0223277 A1
(43) Pub. Date: Jul. 30, 2026

(54) CYCLOTRON

(71) Applicant: NanoMarker, Dion-Valmont (BE)

(72) Inventor: EMILE CONARD, Dion-Valmont (BE)

(73) Assignee: NanoMarker, Dion-Valmont (BE)

(21) Appl. No.: 19/140,471

(22) PCT Filed: Dec. 21, 2023
(86) PCT No.: PCT/EP2023/087252

§ 371 Date: Jun. 18, 2025

(30) Foreign Application Priority Data
Dec. 23, 2022 (BE) BE2022/6078

(51) Int. Cl. H05H 13/02; H01F 1/047; H01F 7/20

(52) U.S. Cl. CPC H05H 13/02; H01F 1/047; H01F 7/202; H05H 2277/116

(57) ABSTRACT

Cyclotron for producing radionuclides for medical applications, the cyclotron comprising an electromagnet, a resonator and a charged particle inlet into the cyclotron and an accelerated charged particle outlet outside the cyclotron, configured to accelerate charged particles to maximum energy below 25 MeV on a smaller scale.

The invention relates to a cyclotron, in particular a cyclotron for medical applications.

A cyclotron is a type of circular particle accelerator in which positively charged or negatively charged particles are injected into the cyclotron by a particle injection system, then the charged particles are accelerated by a radio frequency system, and then guided by a magnetic system, in particular from the centre of the cyclotron towards the outside thereof, along a trajectory having a general spiral shape. The accelerated charged particles thus form a beam of particles (we can also speak of a beam of charged particles or an ion beam). Particles may reach maximum energies of the order of a few MeV to several hundred MeV (eV for electron-volt).

Today, cyclotrons are used in particular in medical applications with the aim of producing radiopharmaceutical products comprising radionuclides (also called radioactive isotopes or radioelements). A radionuclide is obtained by nuclear reaction between an accelerated charged particle and a precursor material. For example, one of the radioactive isotopes is fluorine-18, which is obtained via the nuclear reaction induced by protons with suitable kinetic energy bombarding the stable isotope Oxygen-18 as a precursor material (the reaction is symbolically denoted ¹⁸O(p,n)¹⁸F). Once the radioactive isotopes are created, the radiopharmaceuticals are manufactured and then transferred to a medical centre or hospital for use in medical treatment or diagnosis, for example by PET imaging, positron emission tomography.

Due to the short half-life of commonly used radionuclides (for example, fluorine-18 has a half-life of approximately 110 minutes), it would be more efficient and practical to build a cyclotron inside medical centres or hospitals in order to reduce the time between the creation of the radioactive isotope and its use. The electromagnet of cyclotrons known for medical applications is mainly made of low-carbon steel. The saturation magnetic induction of these materials is generally limited to 1.8 T (Tesla). The maximum energy of the particles accelerated by a cyclotron being essentially proportional to the square of the product B*r (B being the average magnetic field and r the maximum radius of the largest orbit contained in this field), with the aim of increasing the energy of the charged particles, it requires increasing the radius of the poles generating the magnetic field, which results in a greater mass of the cyclotron (which is essentially proportional to the cube of the radius).

Consequently, radionuclide production cyclotrons are often far from hospitals or medical centres, in particular because of their weight (average weight of at least 9 tonnes (9000 kg), and even more with the mass of the shielding encapsulating the cyclotron) and of their size (average diameter of at least 1 m for the poles alone or reduced footprint of at least 30 m²) which make their construction difficult or impossible inside medical centres or hospitals.

It is therefore desirable to provide cyclotrons which can be located as close as possible to the place where the radiopharmaceuticals are needed, preferably at the same place where the radiopharmaceuticals are needed, that is to say at inside or near the hospital or medical centre.

Therefore, we seek to design a cyclotron which is both smaller and less heavy to be installed inside or near medical centres or hospitals, while remaining suitable for the production of particles, for example protons, deuterons or alpha, at sufficient energy to make radioactive isotopes, including radioactive isotopes commonly used in imaging or medical treatments.

According to one of its aspects, the present invention proposes a cyclotron for producing radionuclides for medical applications as defined in claim 1. According to another of its aspects, the invention also relates to a method of producing an element of a cyclotron of an alloy comprising iron and cobalt. Additional aspects of the invention are defined in the independent claims. The dependent claims define preferred and/or alternative embodiments.

According to one aspect, it is disclosed a cyclotron for the production of radionuclides for medical applications, the cyclotron comprising
an electromagnet configured to provide a magnetic field, the electromagnet comprising a yoke, two poles and at least one coil;
a resonator, particularly a high-frequency resonator, configured to accelerate the speed of a charged particle; and
   in which each pole is chosen from
i) a pole comprising a material having a magnetic saturation of at least 1.95 T, in particular a pole comprising at least 80% by weight of a material having a magnetic saturation of at least 1.95 T; or
ii) a pole which is a pole made of an alloy of iron and cobalt, in particular an alloy of iron and cobalt comprising from 14 to 55% by weight of cobalt, preferably from 20 to 50% by weight of cobalt, the remainder being iron and inevitable impurities

The operating principle of a cyclotron is governed by the Lorenz force (F=q·v×B, in the absence of electric force) applied to a charged particle. Because of this force, when a uniform magnetic field is applied to it, the trajectory of the charged particle follows, in the absence of acceleration, essentially an arc in a plane perpendicular to the uniform magnetic field.

Cyclotrons comprise distinct modules such as:
an electromagnet comprising a yoke, two poles and at least one coil, the electromagnet being configured to provide a magnetic field;
a resonator, in particular a high frequency resonator, which is configured to apply an electric potential difference at an adjustable frequency to the particle in order to accelerate its speed; and
a particle inlet comprising a particle injection system in order to bring charged particles into the cyclotron.

The cyclotron may comprise a particle outlet comprising a system for extracting particles from the cyclotron. In this configuration, the trajectory of the particle beam is deflected by the extraction system outside the cyclotron via a particle outlet towards a precursor material. As an alternative to the extraction system, a target comprising the precursor material may be provided inside the cyclotron. In this case, the beam of accelerated particles remains inside the cyclotron. The particle beam is formed of charged particles which are introduced into a space at or near the centre of the cyclotron via an injection system which may consist of a source of particles, and this with an initial velocity (and therefore a kinetic energy) relatively low.

The cyclotron modules are configured to, in combination, accelerate one or more charged particles in a plane that is substantially perpendicular to the generated magnetic field lines, such that the charged particle moves in a substantially spiral path of increasing radius, around of the central axis of the cyclotron, said central axis being perpendicular to the trajectory plane of the charged particle.

The electromagnet includes two poles and a yoke, the yoke substantially encapsulating the poles when the cyclotron is in operating condition. The yoke is adapted to confine the magnetic field lines within the cyclotron in operating condition and prevent the magnetic field lines from propagating outside the cyclotron in operating condition. The yoke may be formed of two or more yoke portions. Preferably, the yoke comprises a first yoke portion and a second yoke portion that may be assembled together in a closed configuration to form the yoke. When the yoke is in a closed configuration, this provides an internal cavity in which the poles, including poles comprising optional sectors, the coil(s), the resonator and the particle inlet may be installed. In a preferred form of the invention, the first and/or second yoke portion are/is a unitary yoke portion.

In particular when the yoke comprises a first and a second yoke portion, one of the first or the second yoke portion is unitary with a pole. Preferably, each yoke portion is unitary with a pole.

By unitary, it is meant that the element is manufactured in a single piece and not from the combination of several elements secured together, for example by bolting or welding.

One or each pole of the electromagnet may comprise, on one of its main surfaces, in particular the main surface of the pole facing the other opposite pole, a plurality of sectors, forming an alternation of hills and valleys, around the central axis of the pole (central axis of the pole which is preferably the main axis of the magnetic field), varying the thickness of the pole around its central axis. Thus, when the sectors are on the surface of the pole facing the opposite pole, this causes the geometry of the space between the two poles to vary when the cyclotron is in operating mode; the shape and arrangement of the sectors on the surface of the pole(s) makes it possible to correct the magnetic flux when it moves away from the central axis of the poles. The arrangement of the sectors may make it possible in particular to guide the charged particles during their accelerated trajectory.

Sectors may be provided as separate elements from the pole with which they are associated. Where the sectors are separate elements, the sectors may be attached to a main surface of a pole by bolting or welding. Alternatively and in a preferred embodiment, the sectors and the associated pole form a unitary part. The lateral surface separating an adjacent hill surface and an adjacent valley surface may be a flat lateral surface or a curved or even spiral lateral surface.

When the sectors are distinct elements of the pole, each sector may be manufactured separately and then secured to a surface of the pole, in particular by bolting, screwing or welding. In a preferred embodiment, each angular sector is fixed at an angular distance spaced from an adjacent sector, the space between two adjacent sectors being sector-free. Alternatively, a plurality of sectors arranged around the axis of the pole are fixed side by side on a surface of a pole, with an alternation between a sector of great thickness and a sector of small thickness. Thus, the sectors providing great thickness to the pole form hills while the angular space between two sectors of great thickness or the angular space sector-free forms valleys.

When the sectors are distinct elements of the pole, the material forming the sectors and the material forming a pole, in particular the pole with which the sectors are associated, are preferably substantially chemically identical, that is to say that the difference in composition for each chemical element of the material is less than 5%. For example the sectors and poles may comprise at least 80% by weight, consist essentially or consist of an alloy of iron and cobalt.

In an alternative embodiment, the sectors may be of a different chemical composition. For example, poles may comprise 80% by weight, consist primarily or consist of an alloy of iron and cobalt while sectors may comprise 80% by weight, consist essentially or consist of soft iron or low carbon steel.

When the sectors and the pole form a unitary part, the pole is machined on one of its surfaces so as to reduce its thickness to angular spaces in order to form hills (local thickness of the pole not or only slightly reduced) and valleys (local thickness of the pole strongly reduced) around the axis of the pole. In this configuration, the part of the pole of reduced thickness forms the valleys while the part of the pole of less reduced thickness forms the hills.

In a preferred embodiment of the invention, the electromagnet comprises two substantially identical unitary parts, each formed of a yoke portion, a pole and optionally sectors forming hills and valleys around the main axis of the pole. Particularly if the hills and valleys formed by the sectors are spiral, the two unitary parts are substantially symmetrical.

When sectors forming hills and valleys are present, the minimum number of sectors is 3 (thus forming 3 hills and 3 valleys).

Preferably, each pole has a cylindrical shape. In particular, when one or each pole has a cylindrical shape, the diameter of one or each pole is greater than the diameter of the acceleration electrodes. This difference in diameter allows the acceleration electrodes to be subjected to, when the cyclotron is in operating condition, a substantially uniform magnetic field along a single main axis, in particular an axis parallel to the main axis of the pole. In a preferred embodiment, the diameter of one or each pole is ≤1.5 m, ≤1 m, ≤0.9 m, ≤0.75 m or ≤0.6 m.

The resonator, comprising acceleration electrodes (Dees or also called “Dés” in French), is preferably a high frequency resonator. By “high frequency” it is meant that the resonator is capable of varying the polarity of an electrode at a frequency of at least 15 MHz. To accelerate the charged particles, the resonator generates an alternating voltage across the acceleration electrodes. In particular, when the cyclotron is an isochronous cyclotron, the frequency of the alternating voltage applied to the acceleration electrodes is set to the cyclotron frequency which depends on the magnetic field and the charge to mass ratio of accelerated particle. The resonator may comprise at least one, two, three, four or more acceleration electrodes, each acceleration electrode being spaced from the adjacent electrode in a plane perpendicular to the magnetic field lines. Increasing the number of acceleration electrodes makes it possible to obtain the same energy gain of the particle with a potential difference applied to the acceleration electrodes reduced proportionally to this number.

The “cyclotron” or cyclotronic frequency of the particles is given by the fundamental relation of the cyclotron: ω=q*B/m (ω=2*pi*F). For example, for a proton (one unit of mass and one unit of charge) in a magnetic field of intensity 1 Tesla, the revolution frequency is 15.25 MHz. The frequency of the resonator may be an integer multiple of the revolution frequency.

The acceleration electrodes may be positioned in the space between the two opposing surfaces of the poles. Alternatively, in particular when the pole(s) comprise(s) sectors forming hills and valleys, the acceleration electrodes may be located in the valleys. This last configuration makes it possible to reduce the gap and create a magnetic field by injecting less current into the coil or coils. Since the power dissipated by the coil is proportional to the square of the input current, it is particularly useful to decrease the amount of input current.

Preferably, one, two or more coils are arranged inside the cavity formed by the yoke when the yoke is in the closed configuration. Preferably, a recess is provided in the yoke in order to be able to arrange the coil(s) during assembly of the cyclotron. Preferably, the coil(s) go(es) completely around the poles. In a preferred embodiment of the invention, the electromagnet has a single coil. Particularly when the electromagnet comprises a single coil, the length of the coil along the central axis may overlap the thicknesses of the two poles. When the cyclotron includes two coils, each coil may extend entirely around each of the two poles. When the cyclotron includes two coils, the length of one or each coil along the central axis may be less than the length of its respective pole. Alternatively, the length of one or each coil along the central axis may be equal to or greater than the length of its respective pole. Preferably, the two coils have a substantially identical length and/or electrical conductivity. Preferably, the two coils are arranged symmetrically with respect to the median plane of the poles.

The electromagnet may include other correction coils to correct the magnetic field profile. The coil, in particular each coil of the cyclotron, is preferably made essentially of an electrically conductive material, in particular a conductive material chosen from copper, a copper alloy, aluminium, an aluminium alloy, or any metal or alloy having an electrical resistivity less than 1×10⁻⁶ Ω·m at 20° C. A material with low electrical resistivity is sought in order to reduce energy losses by Joule effect during its operation. In a preferred embodiment, the or each coil is free or substantially free of superconducting material. Alternatively, the coil may comprise, consist of or consist essentially of a superconducting material, in particular a high temperature superconducting material, that is to say a material having superconducting properties at a temperature above 77K.

The accelerated charged particles may be positively charged particles, for example H+ (protons). The accelerated charged particles may be negatively charged particles, for example H−. The charged particles may be chosen from protium ions (hydrogen without neutron), deuterium (hydrogen whose nucleus contains a proton and a neutron), molecular hydrogen, or helium ions. Alternatively, the accelerated charged particles may be heavier ions, e.g. carbon ions.

The cyclotron may be configured to produce accelerated charged particles having a maximum energy of less than 70 MeV, less than 30 MeV, less than 20 MeV, less than 15 MeV, less than 10 MeV or less than 8 MeV. In a preferred embodiment, the cyclotron is configured to produce accelerated particles with maximum energy in the range of 6-30 MeV, preferably in the range of 6-10 MeV.

One or each pole of the cyclotron preferably has a diameter of at least 25 cm, at least 35 cm, at least 50 cm, at least 70 cm and/or less than 200 cm, less than 150 cm, less than 120 cm, less than 100 cm or less than 80 cm.

The cyclotron preferably has the following combined characteristics
one or each pole has a diameter of at least 25 cm and less than 100 cm, preferably less than 80 cm; and
the cyclotron is configured to produce accelerated charged particles having a maximum energy of at least 6 MeV and less than 20 MeV, preferably less than 15 MeV.

The radionuclides may be chosen from nitrogen-13, oxygen-15, Sc-43, carbon-11, fluorine-18, sodium-22, copper-64, gallium-68 or bromine-77. In particular, when the cyclotron produces accelerated particles of less than 6 MeV, the radionuclides may be nitrogen-13, oxygen-15, Sc-43. In particular, when the cyclotron produces accelerated particles of at least 6 MeV and less than 15 MeV, the radionuclides may be carbon-11, fluorine-18, sodium-22, copper-64, gallium-68 or bromine-77.

One or each pole of the electromagnet may comprise, consist of or consist essentially of a material having a magnetic saturation of at least 1.95 T, preferably at least 2 T, more preferably at least 2.2 T, and even more preferably at least 2.3 T. The material is preferably an alloy of iron and cobalt.

As used herein, the term “consists essentially of” is intended to limit the scope of a claim to the specified materials or steps and those which do not materially affect the fundamental and novel feature(s) of the claimed invention.

In a preferred embodiment, one or each pole of the electromagnet comprises at least 90% by weight, preferably 95% by weight and more preferably at least 99% by weight of a material having a magnetic saturation of at least 1.95 T, preferably at least 2 T, more preferably at least 2.2 T, and even more preferably at least 2.3 T. The material is preferably an alloy of iron and cobalt.

One or each pole of the electromagnet is preferably an iron and cobalt alloy pole. It was found that iron and cobalt alloy provides higher magnetic saturation than low carbon steel electromagnet.

An element or a combination of elements selected from: the yoke, one or each pole, the optional sectors may comprise at least 50% by weight, at least 60% by weight, at least 70% by weight, at least 80% by weight, at least 90% by weight, at least 95% by weight, at least 99% by weight of an alloy of iron and cobalt. Preferably, one or a combination of: the yoke, one or each pole, the optional sectors comprises at least 90% by weight, preferably at least 95% by weight, even more preferably at least 99% by weight of an alloy of iron and cobalt.

The iron and cobalt alloy may comprise cobalt in the range of 14 to 55% by weight or 14 to 50% by weight, preferably in the range of 20 to 30% by weight, the balance being iron and inevitable impurities. Examples of iron and cobalt alloy are known by the following names:
Hiperco 15 (which comprises cobalt in the amount of 14-15% by weight, the remainder being iron and inevitable impurities). The Hiperco 15 has saturation at 2.25 T;
Aperam IMPHY AFK 18 (which comprises cobalt in the amount of 17-19% by weight, the remainder being iron and inevitable impurities). This alloy has a saturation at 2.3 T;
Vacoflux 17 (which comprises 16-18% cobalt by weight, the remainder being iron and inevitable impurities);
Hiperco 27 (which comprises 26-28% cobalt by weight, the remainder being iron and inevitable impurities);
Permendur (which comprises substantially equal parts of cobalt and iron, in particular up to 48-50% by weight, possibly an additive element in an amount less than 5% by weight such as vanadium, and inevitable impurities).
   In a preferred embodiment, the iron and cobalt alloy comprises between 26 and 28% cobalt, the remainder being iron and inevitable impurities. In a preferred embodiment, all the elements chosen from the poles and the yoke, in particular, when applicable, the first yoke portion and the second yoke portion, are elements made of iron and cobalt alloy.

The yoke, in particular the first and second portions of the yoke, may comprise, consist or consist essentially of a material having a magnetic saturation of at least 1.95 T, preferably at least 2 T, more preferably at least 2.2 T, and even more preferably at least 2.3 T.

In a preferred embodiment, the yoke, in particular the first and second yoke portions, comprises at least 90% by weight, preferably 95% by weight and more preferably at least 99% by weight of a material having a saturation magnetic of at least 1.95 T, preferably at least 2 T, more preferably at least 2.2 T, and even more preferably at least 2.3 T. Preferably, the material of the yoke is an alloy of iron and cobalt.

In a preferred embodiment, the yoke, in particular the first and second yoke portions, and each pole may comprise, consist or consist essentially of a material having a magnetic saturation of at least 1.95 T, preferably of at least 2 T, more preferably at least 2.2 T, and even more preferably at least 2.3 T, in particular in an alloy of iron and cobalt.

When each pole, and possibly the yoke, are made of a material having a magnetic saturation of at least 1.95 T or at least 2 T, preferably at least 2.2 T, more preferably at least 2.3 T, it is possible to i) for a same radius, obtain a charged particle with a higher energy, or ii) obtain a maximum energy on a pole of smaller radius.

The other constituent elements of the cyclotron (other than the yoke, the poles and the coil(s)) may be manufactured with the usual materials.

The shape of a cyclotron element, in particular the yoke or one or each pole, is preferably obtained by hot isostatic pressing of an iron and cobalt alloy in particulate form. Preferably, the alloy particles may have a composition consisting or consisting essentially of cobalt in the range of 14 to 55 wt. % or 20 to 55 wt. %, preferably in the range of 20 to 30 wt. %, the rest being iron and inevitable impurities. The iron and cobalt alloy particles may have an average particle size of less than 100 μm, preferably an average particle size in the range 40-90 μm. In previous cyclotrons, the iron and cobalt alloy was only used in small parts such as inflectors or a ring on the periphery of a pole, because it was not possible to make large parts of this alloy. This preferred manufacturing process has a plurality of advantages, e.g.:
it improves the mechanical properties and workability of the alloy;
it improves the homogeneity of the alloy;
it ensures isotropic and reproducible magnetic properties;
it makes it possible to produce an alloy with a more complex and/or larger shape and in particular to produce unitary elements, for example, a pole or a combination of a part of a yoke and a pole;
it allows for smaller, lighter parts with similar or better performance, compared to similar parts made from low carbon steel.

Another advantage of the invention is to simplify the operations of adjusting the magnetic field profile (field mapping and trimming) because the reduction in size makes it possible in particular to install a milling machine on the parts of the magnet (in situ) unlike the conventional technique which requires parts to be disassembled, transported and installed on a milling machine in a machine shop.

The manufacture of cyclotron elements such as the poles and/or the yoke with an iron and cobalt alloy, in particular by a hot isostatic pressing process of iron and cobalt alloy, also makes it possible to reproduce at smaller scale previous designs of existing cyclotrons. Additionally, voids within a casting may be reduced or eliminated and encapsulated powders may be consolidated to create fully dense materials. Dissimilar materials may also be joined together to make unique and cost-effective elements.

Alternatively, the yoke and/or one or each pole, as well as other elements of the cyclotrons may be manufactured according to other manufacturing processes, for example: casting, forging, rolling, machining by removal of material (for example milling, turning or spark erosion), production by additive manufacturing (AM), also known as 3D printing, 3D printing by SLS (selective laser sintering), 3D printing with metal powders. The advantage of production by AM is to produce an almost finished part (net shape) saving the material needed for manufacturing and virtually eliminating any subsequent machining operations.

The cyclotron is preferably an isochronous cyclotron (i.e. the average intensity of the magnetic field varies with the radius while the frequency of the resonator remains constant). Unlike a conventional cyclotron, an isochronous cyclotron is capable of producing particles of higher energy. Alternatively the cyclotron may be a synchro-cyclotron.

A radiological shielding shield may also encapsulate the cyclotron. The radiological shielding shield makes it possible to stop or strongly attenuate the ionizing radiation inevitably produced during cyclotron in operating condition. The cyclotron without a radiological shielding shield may have a mass of less than 5 tonnes (5000 kg), preferably less than 2 tonnes (2000 kg). The total mass of the cyclotron and the radiological shielding shield is preferably less than 20 tonnes (20000 kg).

A pumping system for creating the vacuum is preferably provided to reduce the vacuum inside the cyclotron before the cyclotron is put into operation. Preferably, the vacuum system makes it possible to obtain a pressure when the cyclotron is in operating condition of less than 10⁻⁴ mbar (0.01 Pa).

According to another of its aspects, the invention also relates to a method for manufacturing an element of a cyclotron in an alloy comprising iron and cobalt. The method comprising:
providing an alloy of iron and cobalt in particulate form; and subsequently
subjecting the iron and cobalt alloy in particulate form to a hot isostatic pressing process,
   wherein the element of a cyclotron is selected from a pole, a sector of a pole, a yoke portion and a combination thereof.

Preferably, subjecting the iron and cobalt alloy in particulate form to a hot isostatic pressing process comprises subjecting the iron and cobalt alloy in particulate form to
a pressure of at least 50 MPa, at least 100 MPa and/or less than 300 MPa, less than 250 MPa; and/or
a temperature of at least 400° C., at least 600° C., at least 800° C. and/or less than 1300° C., less than 1000° C.

According to another of its aspects, the invention also relates to a method for manufacturing an element of a cyclotron in an alloy comprising iron and cobalt, the method comprising:
providing a raw material suitable for additive manufacturing in iron and cobalt alloy; and
subjecting the iron and cobalt alloy raw material to an additive manufacturing process.

One embodiment of the invention will now be described, by way of example only, with reference to the attached drawings, among which

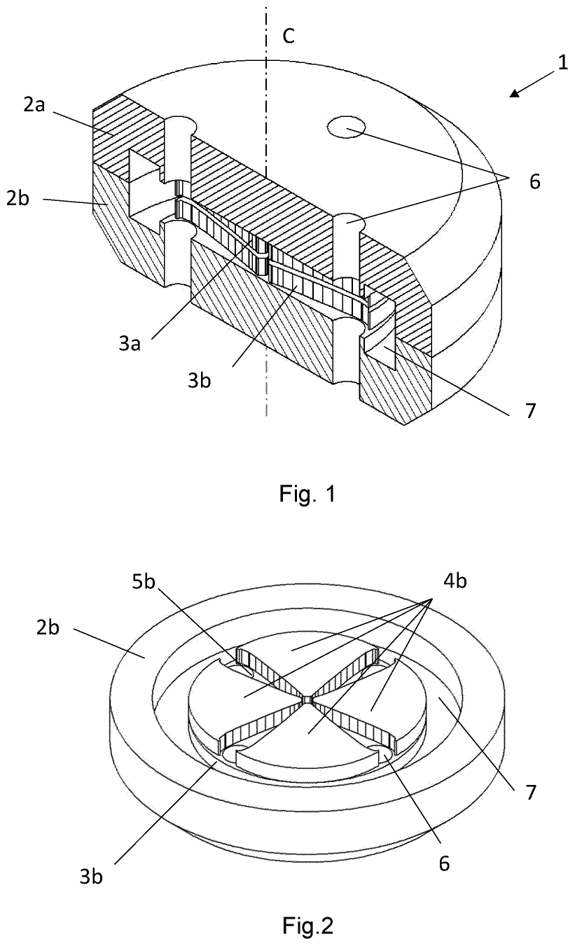

FIG. 1 is a perspective sectional view of a cyclotron according to one embodiment of the invention;

FIG. 2 is a top view of a lower part of a cyclotron of FIG. 1;

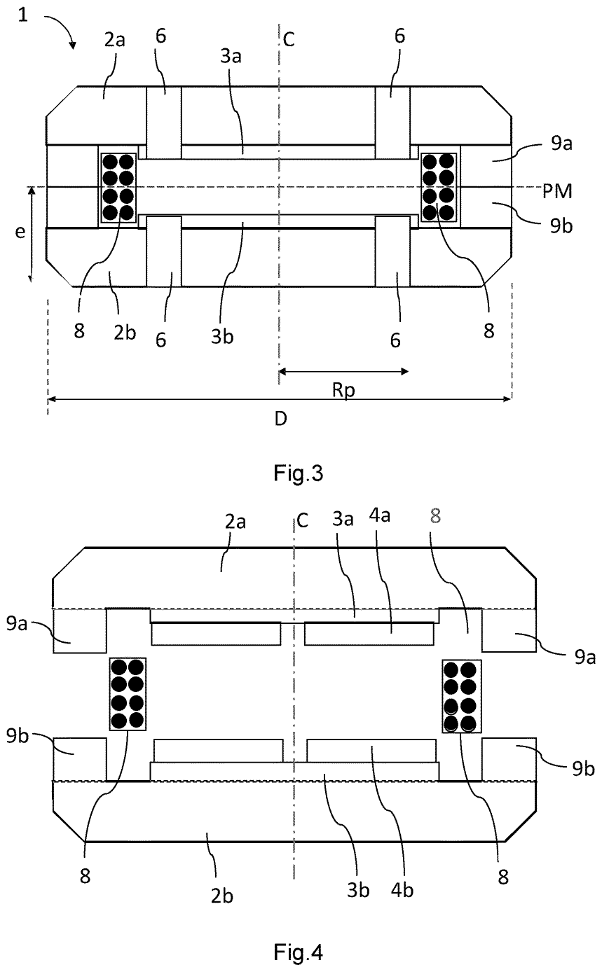

FIG. 3 is a sectional view according to a first section of a cyclotron in “closed” position according to a second embodiment of the invention;

FIG. 4 is a sectional view according to a second section of the cyclotron of FIG. 3 in “open” position;

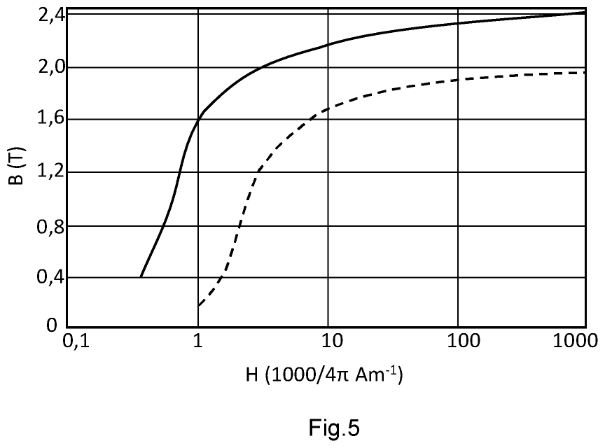

FIG. 5 is a chart of magnetic induction versus magnetization between a low carbon steel and an alloy consisting of 27% by weight of cobalt, the remainder being iron and inevitable impurities.

An iron and cobalt alloy raw material is reduced to an iron and cobalt alloy powder comprising about 27% by weight of cobalt, the remainder being iron and inevitable impurities. The iron and cobalt alloy powder is processed by hot isostatic pressing and shaped to form the elements of cyclotron 1 of FIG. 1:
a yoke 2 formed of a first yoke portion 2a and a second yoke portion 2b. Each of the first and second yoke portions has the shape of a disc and the first and second yoke portions face each other in the direction of extension of a central axis C. An internal cavity in which poles and the coil may be arranged is formed when the yoke is in closed configuration; the yoke portions are essentially symmetrical with respect to the midplane (which is also the plane in which the particle beam is accelerated);
two poles 3a, 3b, one pole being unitary with the interior surface of each of the first yoke portion 2a and the second yoke portion 2b.

Each pole includes a plurality of sectors forming hills 4b and valleys 5b around the central axis. The acceleration electrodes (not shown) are arranged inside the valleys, between two hills.

Around each pole is provided a recess 7 capable of receiving a single copper coil 8 so as to surround the two poles. The dimensions of the upper part and the second yoke portion are substantially identical. The dimensions of each pole are substantially identical.

Each pole has a diameter of about 50 cm.

Openings 6 suitable for evacuating air to obtain sufficient vacuum as well as for the passage of elements of the cyclotron, for example the resonator, are present. Other elements such as a power unit, a control unit, a power source, a power supply for the coil, a radio frequency source for exciting the resonator, a particle inlet, a vacuum system are also provided (not shown).

As illustrated in FIG. 3 and FIG. 4, each yoke portion 2a, 2b may be in 2 separate portions fixed together, one of the portions being a peripheral section 9a, 9b, also called flux return, surrounding a portion of the coil 8. When the cyclotron 1 is in the operating position, the two peripheral sections 9a, 9b substantially surround the coil 8.

FIG. 3 is a plan section view along the central axis and the bisector of the valleys. FIG. 4 is a sectional view along the bisector of the sectors forming the hills.

The present cyclotron 1, comprising a yoke and poles made of iron and cobalt alloy, is compared to a comparative cyclotron in which the yoke and poles are made of low carbon steel:

| | Example of a prior art | | Cyclotron according to the | |
|---|---|---|---|---|
| | cyclotron | | present invention | |
| Pole and yoke material | Low carbon steel | | 27% wt cobalt | |
| | | | 73% wt iron | |
| Pole diameter | 80 | cm | 50 | cm |
| Maximum energy of charged | 9.2 | MeV | 9 | MeV |
| particles | | | | |
| Electrical power consumed | 37 | kW | <7 | kW |
| Reduced footprint | >30 | m² | <12 | m² |
| Reduced mass (without the | 9 | tonnes | <1 | tonne |
| radiological shielding shield) | | | | |
| Total mass (with radiological | 47 | tonnes | <15 | tonnes |
| shielding shield) | | | | |

### REFERENCES IN FIGURES

1: yoke
2a, 2b: yoke portions;
3a, 3b: poles
6: openings
7: recess
C central axis
4a, 4b: sectors forming magnetic “hills”
5a, 5b: sectors forming valleys
PM: the middle plane
D: yoke diameter
Rp: radius of the poles
e: thickness of a yoke portion
8: induction coil
9a and 9b: yoke section (flux return)

1-15. (canceled)

16. A cyclotron for the production of radionuclides for medical applications, wherein the cyclotron is configured to produce charged particles at a maximum energy of at least 6 Mev and less than 25 MeV, the cyclotron comprising:
an electromagnet configured to provide a magnetic field, the electromagnet comprising a yoke, two poles and at least one coil;
a high-frequency resonator configured to accelerate a speed of the charged particles; and in which:
each pole is a pole comprising at least 80% wt of an alloy of iron and cobalt; and
the yoke comprises an iron and cobalt alloy; and in which
the iron and cobalt alloy of the yoke and the iron and cobalt alloy of each pole comprises cobalt in the range of 14 to 55% by weight, the remainder being iron and inevitable impurities;
wherein the yoke of the electromagnet comprises a first yoke portion and a second yoke portion, the first and second yoke portions being configured to be assembled together in a closed configuration; and wherein
the coil is a coil substantially free of superconducting material; and
the diameter of one or each pole is ≤0.75 m; and
the mass of the cyclotron without a radiological shielding shield is less than 3 tonnes.

16. A cyclotron for the production of radionuclides for medical applications, the cyclotron comprising:
an electromagnet configured to provide a magnetic field, the electromagnet comprising a yoke, two poles and at least one coil;
a resonator configured to accelerate the speed of a charged particle; and in which each pole is selected from
i) a pole comprising at least 80% by weight of a material having a magnetic saturation of at least 1.95 T; and
ii) a pole comprising at least 80% wt of an alloy of iron and cobalt, the remainder being iron and inevitable impurities; and wherein the coil is selected from:
a coil substantially free of superconducting material; and
a coil comprising a high temperature superconducting material having superconducting properties at a temperature above 77K.

17. The cyclotron of claim 17, wherein the yoke of the electromagnet comprises a first yoke portion and a second yoke portion, the first and second yoke portions being configured to be assembled together in a closed configuration.

18. The cyclotron of claim 17, in which the yoke of the electromagnet comprises a first yoke portion and a second yoke portion, the first and second yoke portions being configured to be assembled together in a closed configuration, and in which the yoke is selected from
a yoke comprising a first yoke portion which is a first unitary yoke portion; and
a yoke comprising a second yoke portion which is a second unitary yoke portion; and
a yoke comprising a first yoke portion which is a first unitary yoke portion and a second yoke portion which is a second unitary yoke portion.

19. The cyclotron of claim 17, in which one or each of the poles comprises sectors on one of its main surfaces, the sectors forming an alternation of hills and valleys.

20. The cyclotron of claim 17, in which one or each of the poles comprises sectors on one of its main surfaces, the sectors forming an alternation of hills and valleys, and in which the sectors are unitary with the pole.

21. The cyclotron of claim 17, in which the yoke and each pole comprises at least 90% by weight an iron and cobalt alloy.

22. The cyclotron of claim 17, wherein the yoke comprises an iron and cobalt alloy, and in which the iron and cobalt alloy of the yoke and each pole comprises cobalt in the range of 14 to 55% by weight, the remainder being iron and inevitable impurities.

23. The cyclotron of claim 17, in which the mass of the cyclotron without a radiological shielding shield is less than 3 tonnes.

24. The cyclotron of claim 17, in which at least one of: the yoke, the plurality of poles and the sectors of the poles if present, are formed by a process selected from
i) forming by hot isostatic pressing of iron and cobalt alloy particles; and
ii) forming by additive manufacturing of a raw material suitable for additive manufacturing in iron and cobalt alloy.

25. The cyclotron of claim 17, wherein the cyclotron is configured to produce charged particles at a maximum energy of at least 6 Mev and less than 25 MeV.

26. The cyclotron of claim 17, in which the diameter of one or each pole is ≤0.75 m.

27. A method of producing radionuclides for medical applications with a cyclotron, comprising;
providing the cyclotron of claim 17;
providing charged particles and a radionuclide precursor material;
subsequently injecting the charged particles into the cyclotron;
subsequently accelerating the charged particles to form accelerated charged particles; and
subsequently obtaining radionucleotides by nuclear reaction between the accelerated charged particles and the radionuclide precursor material.

28. A method of producing radionuclides for medical applications with a cyclotron, comprising;
providing the cyclotron of claim 16;
providing charged particles and a radionuclide precursor material;
subsequently injecting the charged particles into the cyclotron;
subsequently accelerating the charged particles to form accelerated charged particles; and
subsequently obtaining radionucleotides by nuclear reaction between the accelerated charged particles and the radionuclide precursor material.
